(19) United States
(12) Patent Application Publication
(10) Pub. No.: US 2025/0133034 A1
(43) Pub. Date: Apr. 24, 2025

(54) CONTENTION FREE SCHEDULING OF DATA PACKETS IN INDUSTRIAL ENVIRONMENT

(71) Applicant: TELEFONAKTIEBOLAGET LM ERICSSON (PUBL), Stockholm (SE)

(72) Inventors: Vicknesan AYADURAI, Sollentuna (SE); Sara SANDBERG, Luleå (SE); Peter DE BRUIN, Gammelstad (SE); Ingemar JOHANSSON, Luleå (SE)

(21) Appl. No.: 18/833,152

(22) PCT Filed: Jan. 27, 2022
(86) PCT No.: PCT/SE2022/050086

§ 371 Date: Jul. 25, 2024

(51) Int. Cl. H04L 47/6275; G05B 19/418

(52) U.S. Cl. CPC H04L 47/6275; G05B 19/4185

(57) ABSTRACT

Embodiments of the present disclosure provide a method for scheduling a plurality of data packets from an industrial controller to one or more industrial devices over a wireless communication network. The method includes receiving, from the industrial controller, traffic pattern characteristics associated with the plurality of data packets intended to the one or more industrial devices. The method includes receiving, from a network node in the wireless communication network, timing information related to a plurality of radio resources for transmission of the plurality of data packets. The method includes scheduling the plurality of data packets on the plurality of radio resources using the traffic pattern characteristics and the timing information related to the plurality of radio resources.

### TECHNICAL FIELD

The present disclosure relates generally to the field of industrial environment. More particularly, it relates to methods, scheduling entity, and computer program products for scheduling data packets from an industrial controller to one or more industrial devices over a wireless communication network in an industrial environment.

### BACKGROUND

Industrial automation is becoming increasingly popular due to rapid development in sensors, control system, and other manufacturing techniques. In industrial automation, various kinds of industrial devices (such as 6DOF robotic arms, collaborating robotic arms, Automated Guided Vehicles, AGVs, with omni-wheels, mechanical peripherals, or other robotic devices) are used to automate various process in industries. For example, the industrial environment includes a plurality of industrial devices that receive control messages from an industrial controller, for example, a factory automation equipment, FA, and perform assigned one or more operations.

FIG. 1 discloses an example industrial environment, where the industrial controller is connected to the industrial device over a wired connection. The industrial controller comprises a programmable logic controller, PLC, for controlling the industrial device. The PLC can be directly connected to the industrial device over the wired connection, for example, over cables. The PLC generates data packets for the industrial device to perform the one or more operations. The data packets can be commands/control messages for the industrial device to perform the one or more tasks. The PLC transmits the data packets to the industrial device over the wired connection at pre-defined periodic intervals. Therefore, upon receiving one of the data packets from the PLC, the industrial device can implicitly identify an arrival time of the remaining data packets using a known information pattern combined with a determinism mechanism provided by the wired connection. One of the drawbacks associated with the wired connection involves inhibition of easy relocation of the industrial device. As a result, a possibility of mobility for the industrial controller can be eliminated completely.

Further, when the PLC is connected to the industrial device over the wired connection, the industrial environment requires the data packets generated at the PLC to arrive at the industrial device instantaneously, and without fail. With such a requirement, a control logic for operating the PLC and the industrial device can be implemented without taking into consideration of a possibility that the data packets being delayed in arriving from the PLC to the industrial device over the wired connection.

In order to mitigate the above-described drawbacks associated with the wired connection, a wireless communication network can be utilized to provide a connectivity between the industrial controller and the one or more industrial devices.

FIG. 2A discloses an example industrial environment, where the industrial controller is connected to the industrial device over the wireless communication network. As depicted in FIG. 2A, the PLC of the industrial controller can be connected to the industrial device over the wireless communication network. Further, there exists a pair of modems for transmitting data packets from the PLC of the industrial controller to the industrial device over the wireless communication network. However, timing predictability in transmitting the data packets from the PLC to the industrial device over the wireless communication network can be reduced, as the wireless communication network is a shared environment with finite radio resources when compared to the wired connection. This results in a degradation in a performance of the industrial controller or results in a total failure of the industrial controller.

FIGS. 2B and 2C disclose timing diagrams illustrating transmission of a data packet from the industrial controller to the industrial device over the wireless communication network using the pair of modems. The PLC of the industrial controller transmits the data packet intended for the industrial device to the connected modem over the wired connection. The modem connected to the PLC transmits the data packet on one of radio resources provided by a network node of the wireless communication network, for the transmission of the data packet to the industrial device.

For example, the radio resources comprise transmit time-slots for transmitting the data packets to the industrial device.

For example, as depicted in FIG. 2B, if the modem receives the data packet from the PLC before an occurrence of the transmit-time slot, the modem transmits the data packet to the industrial device on the immediately available transmit-time slot. Thus, there may be a small amount of delay in transmitting the data packet from the PLC to the industrial device.

For example, as depicted in FIG. 2C, if the modem receives the data packet from the PLC after the occurrence of the transmit-time slot, the modem has to hold the data packet until the occurrence of the next transmit-time slot for transmitting the data packet to the industrial device. This introduces a large amount of delay in transmitting the data packet from the PLC to the industrial device. Due to the large amount of delay, jitter can be introduced to the data packet transmitting to the industrial device over the wireless communication network.

If the PLC of the industrial controller and the network node of the wireless communication network operate with synchronized clocks, the data packets generated at the PLC and the radio resources/transmit-time slots associated with the network node can be in a lockstep. Thus, the associated delay, T_{delay}, between incoming data packets and outgoing data packets at the modem can be essentially constant. As a result, there may be no jitter introduced to the data packets transmitting to the industrial device over the wireless communication network. This may not be applicable if the PLC is generating a plurality of separate packet streams, each comprising a plurality of data packets, for the one or more industrial devices.

FIG. 3A discloses an example industrial environment, where the industrial controller is connected to a plurality of industrial devices over the wireless communication network. The PLC of the industrial controller can generate a plurality of packet streams simultaneously for the plurality of industrial devices, wherein each packet stream comprises a plurality of data packets. The PLC forwards the plurality of data packets of the plurality of packet streams to the modem for transmission of the plurality of data packets to the one or more industrial devices over the wireless communication network. Upon receiving the plurality of data packets simultaneously from the PLC, the modem arbitrarily selects a data packet from the plurality of data packets in a non-deterministic manner. The modem transmits the selected data packet to one of the plurality of industrial devices on the available radio resource. The modem holds the remaining data packets and waits for the next available radio resources for transmission of the remaining data packets to the one or more industrial devices. Thus, the plurality of data packets arrived at the modem at a same periodicity can transmit over the wireless communication network at the different periodicity. As a result, there may be multi-packet contention, where the plurality of data packets compete with each other for the available radio resources. The multi-packet contention adds latency variations or jitter to the data packets transmitting to the one or more industrial devices over the wireless communication network. The latency variations or the jitter can degrade the performance of the industrial controller or can be a cause for the total failure of the industrial controller in controlling the one or more industrial devices.

FIG. 3B discloses a timing diagram illustrating transmission of a plurality of data packets from the industrial controller to the one or more industrial devices. As depicted in FIG. 3B, the PLC of the industrial controller generates two packet streams A, and B simultaneously for the two industrial devices. Each packet stream comprises a plurality of data packets. The industrial controller transmits the two packet streams A, and B to the modem simultaneously. The two packet streams A and B arrive at the modem at T_{A} and T_{B} seconds, wherein the T_{A} is identical to the T_{B}. Upon receiving the two packet streams A, and B, the modem arbitrarily selects a data packet from one of the packet streams A, and B and transmits the selected data packet to one of the industrial devices on an available first transmit-time slot or radio resource. The modem holds the remaining data packets, and waits for the next available transmit-time slot for the transmission of the remaining data packets to the one or more industrial devices. For example, as depicted in FIG. 3B, the modem selects and transmits the data packet from the packet stream B on the available first transmit-time slot. The modem holds the data packet of the packet stream A, and waits for the next available transmit-time slot for the transmission of the data packet. As a result, the two packet streams A and B compete for the first transmit-time slot by causing inconsistent inter-packet times while transmitting over the wireless communication network.

The modem can transmit the data packets of the two packet streams A, and B on the same transmit-time slot, based on a time interval of the transmit-time slot. The time interval of the transmit-time slot may indicate a duration of the transmit-time slot. The time interval of the transmit-time slot varies depending on conditions of a radio channel. A good radio channel can yield a “high-data” transmit-time slot and a bad radio channel can yield a “low-data” transmit timeslot. The modem can transmit the data packets of the two packet streams A and B only on the “high-data” transmit slot. However, the modem cannot anticipate the time interval of the transmit-time slots, due to perpetually varying conditions of the radio channel over time.

### SUMMARY

Consequently, there is a need for an improved method and arrangement for scheduling data packets from an industrial controller to one or more industrial devices over a wireless communication network that alleviates at least some of the above cited problems.

It is therefore an object of the present disclosure to provide a method, a scheduler entity, and a computer program product for scheduling data packets from an industrial controller to one or more industrial devices over a wireless communication network to mitigate, alleviate, or eliminate all or at least some of the above-discussed drawbacks of presently known solutions.

This and other objects are achieved by means of a method, a scheduler entity, and a computer program product as defined in the appended claims. The term exemplary is in the present context to be understood as serving as an instance, example or illustration.

According to a first aspect of the present disclosure, a method for scheduling a plurality of data packets from an industrial controller to one or more industrial devices over a wireless communication network is disclosed. The method is performed by a scheduler entity being connected to the industrial controller. The method comprises receiving, from the industrial controller, traffic pattern characteristics associated with the plurality of data packets intended to the one or more industrial devices. The method comprises receiving, from a network node in the wireless communication network, timing information related to a plurality of radio resources for transmission of the plurality of data packets. The method further comprises scheduling the plurality of data packets on the plurality of radio resources using the traffic pattern characteristics and the timing information related to the plurality of radio resources, wherein a delay is added to least one data packet to provide a spread of the plurality of data packets, wherein the delay of the at least one data packet is added based on the traffic pattern characteristics associated with the plurality of data packets.

In some embodiments, the traffic pattern characteristics associated with the plurality of data packets comprise one or more of, a time interval between the plurality of data packets, a size of each of the plurality of data packets, and a priority of each of the plurality of data packets.

In some embodiments, the plurality of radio resources comprises a plurality of transmit-time slots for transmitting the plurality of data packets to the plurality of industrial devices.

In some embodiments, the plurality of resources is associated with one or more of, a transmit time interval, TTI, a subcarrier spacing, SCS, of the wireless communication network, a transport block size, TBS, and a modulation and coding scheme, MCS, supported by the wireless communication network.

In some embodiments, the timing information related to the plurality of radio resources comprises one or more of, a periodicity of each of the plurality of radio resources and a time interval of each of the plurality of resources.

In some embodiments, the step of scheduling the plurality of data packets on the plurality of radio resources comprises receiving the plurality of data packets from the industrial controller intended for the one or more industrial devices. The method further comprises determining the delay for each of the plurality of data packets by analysing the traffic pattern characteristics, and the timing information related to the plurality of radio resources. The method further comprises scheduling the plurality of data packets on the plurality of radio resources in accordance with the delay determined for each of the plurality of data packets.

In some embodiments, the step of scheduling the plurality of data packets on the plurality of radio resources in accordance with the delay determined for each of the plurality of data packets comprises selecting a data packet from the plurality of data packets based on the delay associated with each of the plurality of data packets. The method further comprises scheduling the selected data packet on a radio resource from the plurality of radio resources for the transmission of the selected data packet to the one or more industrial devices. The method further comprises buffering one or more data packets according to an order of the delay associated with the one or more data packets for scheduling on the plurality of radio resources.

According to a second aspect of the present disclosure, a scheduler entity configured to operate in an industrial environment for scheduling a plurality of data packets from an industrial controller to one or more industrial devices over a wireless communication network is provided. The scheduler entity being configured to cause reception of traffic pattern characteristics associated with the plurality of data packets intended to the one or more industrial devices from the industrial controller. The scheduler entity is configured to cause reception of timing information related to a plurality of radio resources for transmission of the plurality of data packets from a network node in the wireless communication network. The scheduler entity is configured to cause scheduling of the plurality of data packets on the plurality of radio resources using the traffic pattern characteristics and the timing information related to the plurality of radio resources, wherein a delay is added to least one data packet to provide a spread of the plurality of data packets, wherein the delay of the at least one data packet is added based on the traffic pattern characteristics associated with the plurality of data packets.

A third aspect is a scheduler entity comprising the apparatus of the second aspect.

According to a fourth aspect of the present disclosure, a scheduler entity configured to operate in a network node in a wireless communication network for scheduling a plurality of data packets from an industrial controller to one or more industrial devices is provided. The scheduler entity being configured to cause reception of traffic pattern characteristics associated with the plurality of data packets intended to the one or more industrial devices from the industrial controller. The scheduler entity is configured to cause reception of timing information related to a plurality of radio resources for transmission of the plurality of data packets from a network node in the wireless communication network. The scheduler entity is configured to cause scheduling of the plurality of data packets on the plurality of radio resources using the traffic pattern characteristics and the timing information related to the plurality of radio resources, wherein a delay is added to least one data packet to provide a spread of the plurality of data packets, wherein the delay of the at least one data packet is added based on the traffic pattern characteristics associated with the plurality of data packets.

According to a fifth aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for scheduling a plurality of data packets from an industrial controller to one or more industrial devices over a wireless communication network.

An advantage of some embodiments is that efficient usage of a plurality of radio resources for scheduling the data packets from the industrial controller to the one or more industrial devices over the wireless communication network.

An advantage of some embodiments is that scheduling the plurality of data packets on the plurality of radio resources for transmission of the plurality of data packets to the one or more industrial devices, using traffic pattern characteristics associated with the plurality of data packets and timing information related to the plurality of radio resources. Thus, the plurality of data packets may be evenly distributed into the plurality of radio resources.

An advantage of some embodiments is that a delay may be added to at least one data packet based on the traffic pattern characteristics associated with the plurality of data packets to schedule on at least one radio resource. As a result, multi-packet contention, where the plurality of data packets compete with each other for the plurality of radio resources, may be avoided.

An advantage of some embodiments is that buffering or scheduling of the at least one data packet on the at least one radio resource in accordance with the delay associated with each of the plurality of the data packets. Therefore, ensuring a better spacing in a received packet stream comprising the plurality of data packets.

An advantage of some embodiments is that there may be elimination of an amplification of misalignment of the plurality of radio resources and congestion issues, due to the delay added to the at least one data packet for scheduling on the radio resources.

An advantage of some embodiments is that the plurality of data packets may be scheduled on the plurality of radio resources with a same periodicity as originally generated by the industrial controller.

An advantage of some embodiments is that there may be a reduced jitter in the plurality of data packets while transmitting to the one or more industrial devices over the wireless communication network, when the delay is added to the at least one data packet for scheduling on the at least one radio resource.

An advantage of some embodiments is that there may be reduced interference and collisions between the plurality of data packets over the wireless communication. As a result, there may be an increased radio efficiency with improved capacity.

An advantage of some embodiments is that an overall performance of the industrial controller may be improved due to the reduced interference and collisions between the plurality of data packets.

An advantage of some embodiments is that the industrial controller with precise timing requirements in an industrial environment may operate over the wireless communication network that is being simultaneously used by the one or more industrial devices.

An advantage of some embodiments is that the industrial environment may operate over the wireless communication network with low jitter tolerance.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example industrial environment, where an industrial controller is connected to an industrial device over a wired connection;

FIG. 2A discloses an example industrial environment, where the industrial controller is connected to the industrial device over a wireless communication network;

FIG. 2B and 2C disclose timing diagrams illustrating transmission of data packets from the industrial controller to the industrial device over the wireless communication network using a pair of modems;

FIG. 3A discloses an example industrial environment, where the industrial controller is connected to a plurality of industrial devices over the wireless communication network;

FIG. 3B discloses a timing diagram illustrating transmission of a plurality of data packets from the industrial controller to the plurality of industrial devices over the wireless communication network;

FIG. 4 discloses an example industrial environment according to some embodiments;

FIG. 5 is a signaling diagram illustrating example signaling according to some embodiments

FIG. 6 is a flowchart illustrating example method steps according to some embodiments;

FIG. 7 is a flowchart illustrating example method steps according to some embodiments;

FIG. 8 is a flowchart illustrating example method steps according to some embodiments;

FIG. 9 is a schematic block diagram illustrating an example apparatus according to some embodiments;

FIG. 10 is a block diagram of a scheduler entity for contention free scheduling of data packets in the industrial environment, according to some embodiments;

FIG. 11 is a timing diagram illustrating scheduling of a plurality of data packets from an industrial controller to a plurality of industrial devices over a wireless communication network, according to some embodiments; and

FIG. 12 discloses an example computing environment according to some embodiments.

### DETAILED DESCRIPTION

Aspects of the present disclosure will be described more fully hereinafter with reference to the accompanying drawings. The apparatus and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

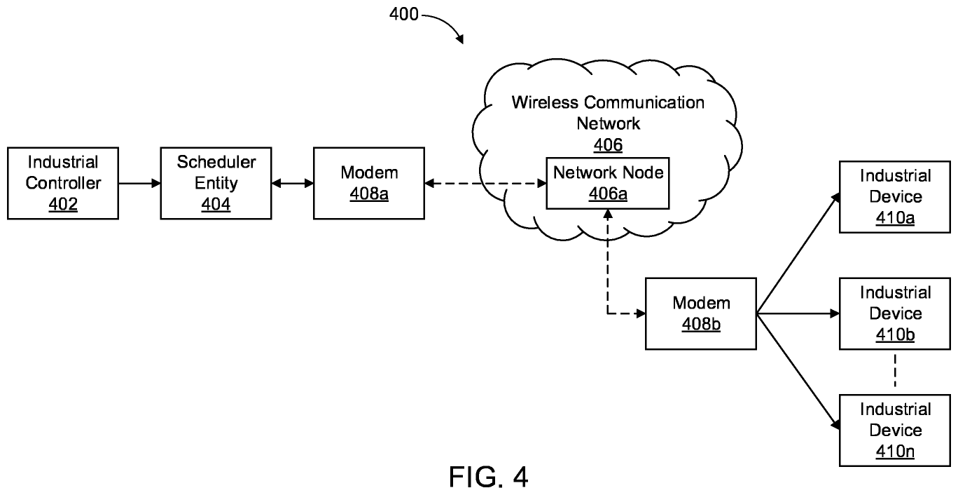

FIG. 4 discloses an example industrial environment 400. Some of the examples of the industrial environment 400 may include a factory, a manufacturing unit, guided robotic environment, or the like. The industrial environment 400 comprises an industrial controller 402, a scheduler entity 404, and a plurality of industrial devices 410a-410n. In some embodiments, the scheduler entity 404 may be connected to the industrial controller 402 and to a network node 406a of a wireless communication network 406. The scheduler entity 404 may be connected to the industrial controller 402 over a wired connection. The scheduler entity 404 may be connected to the network node 406a through a modem 408a. In some embodiments, the scheduler entity 404 may be present as a part of the network node 406 of the wireless communication network 406. Further, the plurality of industrial devices 410a-410n may be connected to the network node 406a of the wireless communication network 406 through a modem 408b. It should be noted that the industrial environment 400 is not limited to above-mentioned components, other components can also be present in the industrial environment 400 other than the components shown in the FIG. 4.

In some examples, the industrial controller 402 is an automation equipment that monitors and controls one or more operations of the plurality of industrial devices 410a-410n over the wireless communication network 406. The industrial controller 402 generates a plurality of commands for controlling the one or more operations of the plurality of industrial devices 410a-410n. The industrial controller 402 transmits the plurality of commands to the industrial devices 410a-410n as packet streams over the wireless communication network 406.

In some examples, the industrial controller 402 may generate the different packet streams for the one or more industrial devices 410a-410n simultaneously. The packet stream comprises a plurality of data packets and may also be referred to as a traffic stream, a data packet stream, or the like.

In some examples, each data packet indicates one or more of, a command, a control message, information, a signal, or the like, for the intended one or more industrial devices 410a-410n to perform the one or more operations.

The industrial controller 402 may include suitable programmable logic controller, PLC, circuitry, interfaces, and/or code that may be configured to control the one or more operations of the plurality of industrial devices 410a-410n. In some examples, the PLC may be implemented in a cloud environment. Examples of the industrial controller 402 may include, but are not limited to, a factory automation equipment, FA equipment, a computing device, a multi-processor system, a microprocessor-based or programmable consumer electronic device, a network computing device, a minicomputer, a mainframe computer, or a combination thereof. The computing device may include a cellular phone, a personal digital assistant, PDA, a handheld device, a laptop computer, or a combination thereof.

In some examples, the scheduler entity 404 may be a device connected to the industrial controller 402 and to the network node 406a of the wireless communication network 406. The scheduler entity 404 may be connected to the industrial controller 402 over the wired connection. Examples of the wired connection may include, but are not limited to, a cable, a telephone network, a fibre-optic connection, a Local Area Network, LAN, a Wide Area Network, WAN, an Ethernet, and so on. The scheduler entity 404 may be connected to the network node 406a of the wireless communication network 406 through the modem 408a.

In some examples, the scheduler entity 404 may be a device residing in the network node 406a of the wireless communication network 406.

The scheduler entity 404 may be configured to receive the plurality of data packets from the industrial controller 402 intended for the one or more industrial devices 410a-410n and schedule the plurality of data packets to the one or more industrial devices 410a-410n over the wireless communication network 406.

In some examples, the wireless communication network 406 may include, but are not limited to, a cellular network, a wireless LAN, Wi-Fi, Bluetooth, Bluetooth low energy, Zigbee, Wi-Fi direct, WFD, Ultra-wideband, UWB, infrared data association, IrDA, near field communication, NFC, and so on. The wireless communication network 406 comprises the network node 406a. The network node 406a may be a radio node connected to the scheduler entity 404 through the modem 408a and to the plurality of industrial devices 410a-410n through the modem 408b. The network node 406a may also be referred to as a base station, an evolved node base station, and so on.

The network node 406a provides a plurality of radio resources for transmission of the plurality of data packets from the industrial controller 402 to the one or more industrial devices 410a-410n.

The network node 406a may be configured to receive the plurality of data packets from the scheduler entity 404 through the modem 408a on the plurality of radio resources and transmit the plurality of data packets to the intended one or more industrial devices through the modem 408b.

In some examples, the modems 408a and 408b may be a transceiver device connecting the scheduler entity 404 and the plurality of industrial devices 410a-410n respectively to the network node 406a of the wireless communication network 406. The modem 408a connected to the scheduler entity 404 may be configured to receive the data packet from the scheduler entity 404 and forward the received data packet to the network node 406a on the radio resources provided by the network node 406a. The modem 408b connected to the plurality of industrial devices 410a-410n may be configured to receive the data packet from the network node 406a and forward the received data packet to the intended one or more industrial devices 410a-410n. In some examples, the modems 408a, and 408b may include, but are not limited to, a broadband device, a router, an internet hub, an Ethernet hub, or the like.

In some examples, the plurality of industrial devices 410a-410n may be a wireless device that is stationary or mobile and also may be referred to as a terminal, a peripheral, a machinery, a node, or the like. The wireless device may be an industrial robot, a robotic arm, an automation cell, a conveyor, a lifter, a turn-over machine, an Internet of Things device, IoT device, a 6DOF robotic arm, collaborating robotic arms, Automated Guided Vehicles, AGVs, with omni-wheels, or other any other similar device. The plurality of industrial devices 410a-410n may be configured to receive the plurality of data packets generated at the industrial controller 402 from the network node 406a through the modem 408b and perform the one or more operations in accordance with the received plurality of data packets. The one or more operations performed by each of the industrial devices 410a-410n may depend on an industrial application being implemented on each of the industrial devices 410a-410n. The industrial application may include, an industrial process automation based application, a building automation based application, an application intended for monitoring electrical distribution networks, or the like.

In the industrial environment 400, when the industrial controller 402 generates and transmits the plurality of data packets to the modem 408a and the modem 408a has to select one of the plurality of data packets arbitrarily in a non-deterministic manner. Further, the modem 408a transmits the selected data packet to one of the industrial devices 410a-410n on the radio resource available at the network node 406a by momentarily holding the other data packets. As a result, there may exist multi-packet contention where the plurality of data packets compete with each other for the radio resources.

Therefore, according to some embodiments of the present disclosure, the scheduler entity 404 implements a method for contention free scheduling of the plurality of data packets from the industrial controller 402 to the one or more industrial devices 410a-410n over the wireless communication network 406.

According to some embodiments of the present disclosure, the scheduler entity 404 receives traffic pattern characteristics associated with the plurality of data packets from the industrial controller 402. The plurality of data packets may be generated by the industrial controller 402 for the one or more industrial devices 410a-410n.

In some examples, the traffic pattern characteristics indicate one or more of, a traffic flow of the plurality of data packets in the packet stream and a behaviour of each data packet. The traffic pattern characteristics comprise one or more of, a time interval between the plurality of data packets, a size of each of the plurality of data packets, and a priority of each of the plurality of data packets.

The scheduler entity 404 also receives timing information related to the plurality of radio resources from the network node 406a of the wireless communication network 406. The plurality of radio resources may be provided by the network node 406a for transmission of the plurality of data packets from the industrial controller 402 to the one or more industrial devices 410a-410n.

For example, the plurality of radio resources comprises a plurality of transmit-time slots for the transmission of the plurality of data packets to the one or more industrial devices 410a-410n. In some examples, the plurality of radio resources may be associated with one or more of, a transmit time interval, TTI, a subcarrier spacing, SCS of the wireless communication network 406, a transport block size, TBS, and a modulation and scheme, MCS, supported by the wireless communication network 406.

In some examples, the timing information related to the plurality of radio resources comprises one or more of, a periodicity of each of the plurality of radio resources, and a time interval of each of the plurality of radio resources. The periodicity of each of the plurality of radio resources indicates an arrival time or an occurrence of the radio resource. The time interval of each of the plurality of radio resources indicates a duration of the radio resource.

When the traffic pattern characteristics and the timing information are received by the scheduler entity 404, the scheduler entity 404 schedules the plurality of data packets on the plurality of radio resources using the traffic pattern characteristics and the timing information related to the plurality of radio resources. The scheduler entity 404 adds a delay to at least one data packet to spread the plurality of data packets on the plurality of radio resources. The scheduler entity 404 adds the delay for the at least one data packet based on the traffic pattern characteristics associated with the plurality of data packets. Thereby, resulting in contention free scheduling of the plurality of data packets on the plurality of radio resources. Various embodiments for scheduling the plurality of data packets from the industrial controller 402 to the one or more industrial devices 410a-410n over the wireless communication network 406 are explained in conjunction with figures in the later parts of the description.

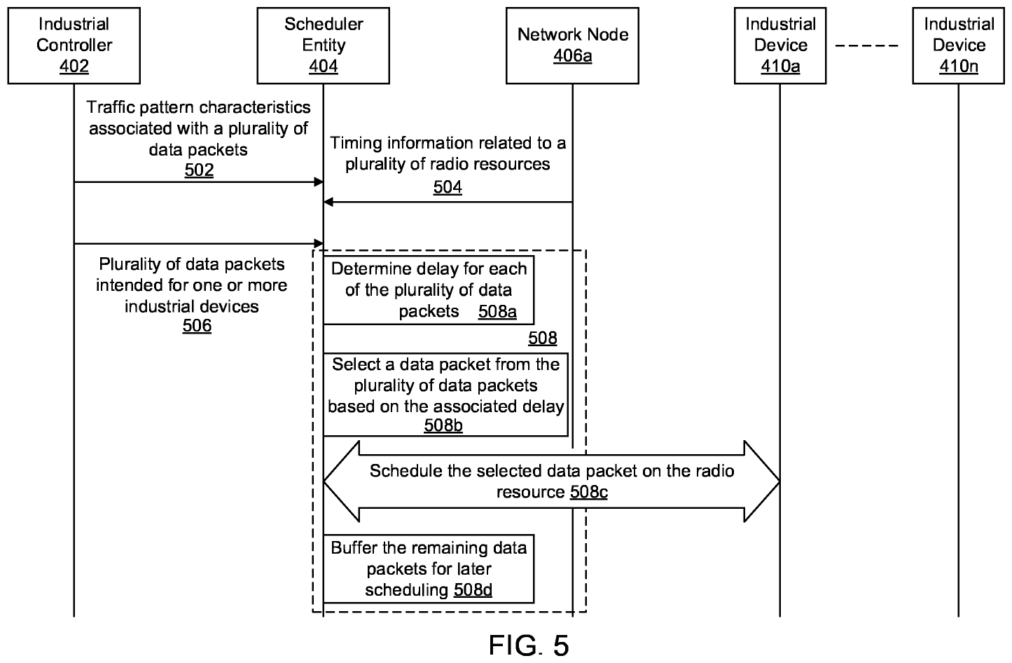

FIG. 5 is a signaling diagram illustrating example signaling for scheduling of a plurality of data packets from the industrial controller 402 to the one or more industrial devices 410a-410n over the wireless communication network 406. The industrial controller 402 transmits 502 traffic pattern characteristics associated with the plurality of data packets to the scheduler entity 404. The traffic pattern characteristics associated with the plurality of data packets indicate a traffic flow of the plurality of data packets in a packet stream and a behaviour associated with each data packet. For example, the traffic pattern characteristics comprise one or more of, a time interval between the plurality of data packets, and a size and priority of each data packet.

The network node 406a of the wireless communication network 406 transmits 504 timing information related to a plurality of radio resources to the scheduler entity 404. The plurality of radio resources comprises a plurality of transmit-time slots for transmitting the plurality of data packets from the industrial device 402 to the one or more industrial devices 410a-410n. The timing information comprises one or more of, a periodicity of each of the plurality of radio resources, and a time interval of each of the plurality of radio resources.

The industrial controller 402 transmits 506 the plurality of data packets to the scheduler entity 404. The plurality of data packets may be intended for the one or more industrial devices 410a-410n. In some examples, the industrial controller 402 transmits the plurality of data packets to the scheduler entity 404 in different packet streams.

In response to the reception of the plurality of data packets, the scheduler entity 404 schedules 508 the plurality of data packets on the plurality of radio resources using the traffic pattern characteristics associated with the plurality of data packets and the timing information related to the plurality of radio resources.

To schedule the plurality of data packets on the plurality of radio resources, the scheduler entity 404 determines 508a a delay for each data packet by analysing the traffic pattern traffic pattern characteristics associated with the plurality of data packets and the timing information related to the plurality of radio resources. For example, the scheduler entity 404 analyses one or more of, the time interval between the plurality of data packets, the size and priority of each data packet, the periodicity of each of the plurality of radio resources, and the time interval of each of the plurality of radio resources. Determining the delay for each data packet results in even distribution/mapping of the plurality of data packets on the plurality of radio resources.

Upon determining the delay for each data packet, the scheduler entity 404 selects 508b a data packet from the plurality of data packets. The scheduler entity 404 selects the data packet by analysing the delay associated with each of the plurality of data packets and the traffic pattern characteristics like a priority associated with each of the plurality of data packets. Thus, the selected data packet may be associated with the lowest delay and the highest priority compared to the other data packets.

The scheduler entity 404 schedules 508c the selected data packet on a radio resource of the plurality of radio resources for transmission of the selected data packet to the one or more industrial devices 410a-410n.

The scheduler entity 404 buffers 508d the one or more data packets in an order of the delay associated with the one or more data packets for scheduling on the radio resources. For example, the scheduler entity 404 buffers the one or more data packets in an ascending order of the delay.

For example, the scheduler entity 404 receives data packets A, B, C, and D. The scheduler entity 404 determines a delay for each of the data packets A-D, by analysing one or more of, a time interval between the data packets A-D, a size and a priority of each of the data packets A-D, a periodicity of each of the plurality of radio resources, for example, time slots A, B, C, and D, and a time interval of each of the time slots A-D. For example, the scheduler entity 404 may determine the delay for the data packets A, B, C, and D as 0 milliseconds, ms, 2 ms, 4 ms, and 6 ms, respectively. Upon determining the delay for each of the data packets A-D, the scheduler entity 404 selects the data packet A, as the data packet A is associated with the lowest delay and the highest priority compared to the other data packets B, C, and D. The scheduler entity 404 schedules the data packet A on the time slot A for transmission of the data packet A to one of the industrial devices 410a-410n. The scheduler entity 404 buffers the data packets B, C, and D for scheduling on the time slots B, C, and D, respectively. As a result, the data packet associated with the lowest delay/latency and the highest priority compared to the other packets may be scheduled first and the other data packets may be buffered for the later scheduling.

Thus, buffering and scheduling of at least one data packet on at least one radio resource avoids multi-packet contention, where the plurality of data packets compete with each other for the radio resources. As a result, no jitter may be added to the data packets transmitting to the one or more industrial devices 410a-410n over the wireless communication network 406, thereby, yielding a conducive user plane performance of the industrial controller 402.

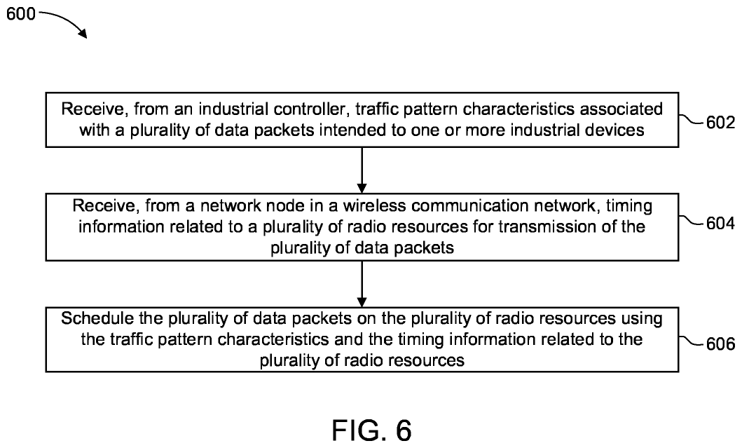

FIG. 6 is a flowchart illustrating example method steps of a method 600 performed by the scheduler entity 404 in the industrial environment 400 for scheduling a plurality of data packets from the industrial controller 402 to the one or more industrial devices 410a-410n.

At step 602, the method 600 comprises receiving, from the industrial controller 402, traffic pattern characteristics associated with the plurality of data packets intended for the plurality of industrial devices 410a-410n. The traffic pattern characteristics comprise one or more of, a time interval between the plurality of data packets, a size of each of the plurality of data packets, and a priority of each of the plurality of data packets.

At step 604, the method 600 comprises receiving, from the network node 406a of the wireless communication network 406, timing information related to a plurality of radio resources for transmission of the plurality of data packets to the one or more industrial devices 410a-410n.

The plurality of radio resources comprises a plurality of transmit-time slots for the transmission of the plurality of data packets to the one or more industrial devices. The plurality of radio resources may be associated with one or more of, a TTI, a SCS of the wireless communication network 406, a TBS, and a MCS supported by the wireless communication network 406.

The timing information related to the plurality of radio resources comprises one or more of, a periodicity of each of the plurality of radio resources, and a time interval of each of the plurality of radio resources.

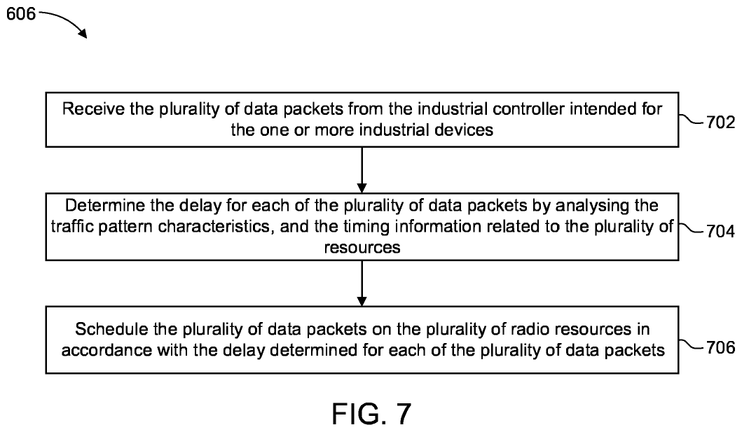

At step 606, the method 600 comprises scheduling the plurality of data packets on the plurality of radio resources using the traffic pattern characteristics associated with the plurality of data packets and the timing information related to the plurality of radio resources. The method comprises adding a delay to at least one data packet to provide a spread of the plurality of data packets. The delay may be added to the at least one packet based on the traffic pattern characteristics associated with the plurality of data packets. The step 606 of scheduling the plurality of data packets on the plurality of radio resources is described in detail in conjunction with FIG. 7.

FIG. 7 is a flowchart illustrating the example method step 606 performed by the scheduler entity 404 to schedule the plurality of data packets on the plurality of radio resources. The step 606 may comprise of steps 702, 704, and 706.

At step 702, the method comprises receiving, from the industrial controller 402, the plurality of data packets intended for the one or more industrial devices 410a-410n. The plurality of data packets may be generated by the industrial controller 402 for controlling the one or more operations of the one or more industrial devices 410a-410n. The plurality of data packets may belong to a plurality of different packet streams.

At step 704, the method comprises determining a delay for each of the plurality of data packets by analysing the timing information associated with the plurality of data packets and the timing information related to the plurality of radio resources. For example, the delay may be determined for each of the plurality of data packets by analysing one or more of, a time interval between the plurality of data packets, a size and a priority of each of the plurality of data packets, a periodicity associated with each of the plurality of radio resources, and a time interval of each of the plurality of radio resources.

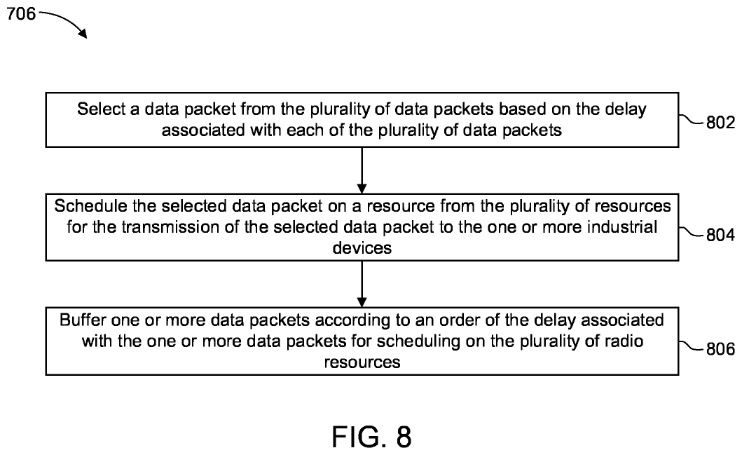

At step 706, the method comprises scheduling the plurality of data packets on the plurality of radio resources in accordance with the delay determined for each of the plurality of data packets. Thus, mapping each of the plurality of data packets with one of the plurality of radio resources. The step 706 of scheduling the plurality of data packets in accordance with the delay is described in detail in conjunction with FIG. 8.

FIG. 8 is a flowchart illustrating the example method step 706 performed by the scheduler entity 404 to schedule the plurality of data packets in accordance with the delay determined for each of the plurality of data packets. The step 706 may comprise of steps 802, 804, and 806.

At step 802, the method comprises selecting a data packet from the plurality of data packets based on the delay associated with each of the plurality of data packets. The selected data packet may be associated with the lowest delay and the highest priority compared to the other data packets.

At step 804, the method comprises scheduling the selected data packet on a radio resource of the plurality of radio resources for transmission of the selected data packet to the one or more industrial devices 410a-410n.

At step 806, the method comprises buffering the one or more data packets in an order of the delay associated with the one or more data packets for scheduling on the radio resources. The buffered one or more data packets may be associated with the highest delay and the lowest priority compared to the data packet selected for scheduling.

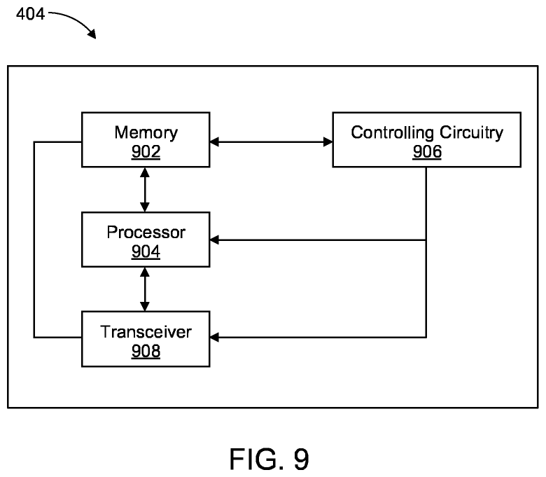

FIG. 9 is an example schematic diagram showing an apparatus 404. The apparatus 404 may e.g. be comprised in a scheduler entity. The apparatus 404 is capable of scheduling the plurality of data packets from the industrial controller 402 to the one or more industrial devices 410a-410n over the wireless communication network 406 and may be configured to cause performance of the method 600 for scheduling the plurality of data packets from the industrial controller 402 to the one or more industrial devices 410a-410n over the wireless communication network 406.

According to at least some embodiments of the present invention, the apparatus 404 in FIG. 9 comprises one or more modules. These modules may e.g. be a memory 902, a processor 904, a controlling circuitry 906, and a transceiver 908. The controlling circuitry 906, may in some embodiments be adapted to control the above mentioned modules.

The memory 902, the processor 904 and the transceiver 908 as well as the controlling circuitry 706, may be operatively connected to each other.

The transceiver 908 may be adapted to receive the traffic pattern characteristics associated with the plurality of data packets from the industrial controller 402, and the timing information related to the plurality of radio resources from the network node 406a of the wireless communication network 406.

The controlling circuitry 906 may be adapted to control the steps as executed by the scheduling entity 404. For example, the controlling circuitry 906 may be adapted to schedule the plurality of data packets on the plurality of radio resources by determining the delay of the at least one data packet using the traffic pattern characteristics, and the timing information. Thus, the controlling circuitry 906 may be adapted to schedule the plurality of data packets from the industrial controller 402 to the one or more industrial devices 410a-410n (as described above in conjunction with the method 600 and FIG. 6).

In addition, the transceiver 908 is also adapted to transmit the data packet on the scheduled radio resource for the transmission of the data packet to the one or more industrial devices 410a-410n.

Further, the processor 908 is adapted to identify the availability of the radio resources, and the one or more industrial devices 410a-410n for transmission of the plurality of data packets.

Furthermore, the memory 902 is adapted to store the traffic characteristics associated with the plurality of data packets, the timing information related to the one or more industrial devices 410a-410n, the delay determined for each of the plurality of data packets, and the data packets selected for buffering.

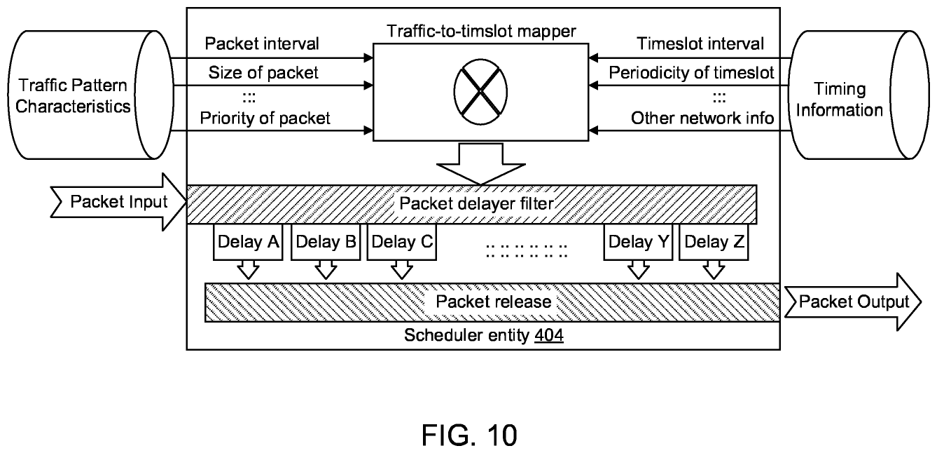

FIG. 10 is a block diagram of the scheduler entity 404 for contention free scheduling of data packets in the industrial environment. As depicted in FIG. 10, the scheduler entity 404 schedules a plurality of data packets from the industrial controller 402 to the one or more industrial devices 410a-410n over the wireless communication network 406.

The scheduler entity 404 receives traffic pattern characteristics associated with a plurality of data packets, for example, data packets A-Z from the industrial controller 402. For example, the traffic pattern characteristics include a time interval between the data packets A-Z, a size of each of the data packets A-Z, and a priority of each of the data packets A-Z. The scheduler entity 404 also receives timing information related to the plurality of radio resources from the network node 406a of the wireless communication network 406. For example, as depicted in FIG. 10, the plurality of radio resources comprises transmit-time slots, for example, time slots A-Z, for transmission of the data packets A-Z to the one or more industrial devices 410a-410n. The timing information related to the time slots A-Z includes a periodicity of each of the time slots A-Z, and a time interval of each of the time slots A-Z.

The scheduler entity 404 receives a packet input from the industrial controller 402. The packet input may comprise of the data packets A-Z, intended to the one or more industrial devices 410a-410n. The scheduler entity 404 adds delay A-Z to the data packets A-Z by analysing one or more of, the time interval between the data packets A-Z, the size and priority of each of the data packets A-Z, the periodicity of each of the time slots A-Z, and the time interval of each of the time slots A-Z. For example, the scheduler entity 404 adds the delay A to the data packet A by analysing that the priority of the data packet A is higher than the priority of other data packets B-Z, and the size of the data packet A matches the time interval of the time slot A, wherein the delay A is associated with a zero value.

Upon adding the delay for the data packets A-Z, the scheduler entity 404 schedules/outputs the data packets A-Z on the time slots A-Z, based on the delay associated with each of the data packets A-Z. For example, the scheduler entity 404 schedules the data packet A on the time slot A and buffers the remaining data packets B-Z for later scheduling on the time slots B-Z, for transmission of the data packets A-Z to the plurality of industrial devices 410a-410n.

Thus, the scheduler entity 404 adds the delay to the data packets in such a way that the data packets do not compete with each other for the transmit-time slots.

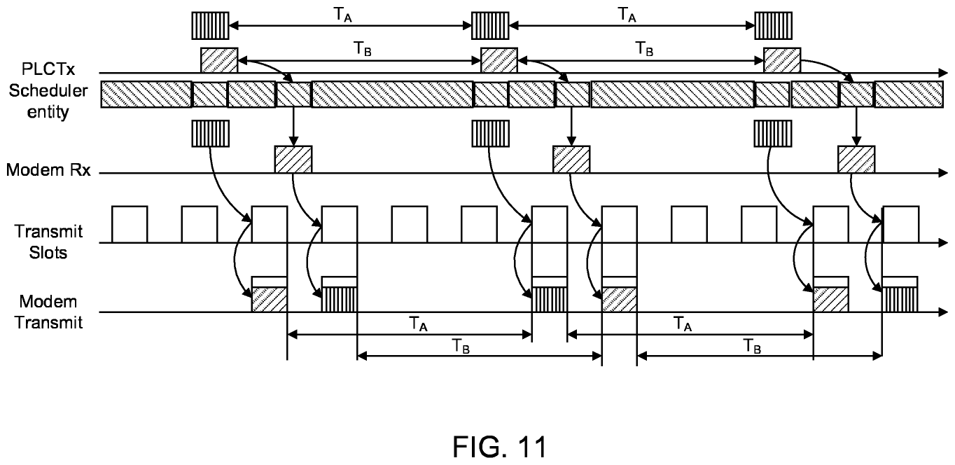

FIG. 11 is a timing diagram illustrating scheduling of a plurality of data packets from the industrial controller 402 to the plurality of industrial devices 410a-410n over the wireless communication network 406. As depicted in FIG. 11, the industrial controller 402 generates two different packet streams A and B for two industrial devices 410a, and 410b simultaneously using a PLC. Each packet stream comprises a plurality of data packets. The industrial controller 402 inputs the two packet streams A and B to the scheduler entity 404. Upon receiving the two packet streams, the scheduler entity 404 determines traffic pattern characteristics associated with the plurality of data packets of the two packet streams A, and B. For example, the scheduler entity 404 determines a time interval between the plurality of data packets arriving from the two packet streams A, and B, and a size and priority of each of the plurality of data packets arriving from the two packet streams A, and B.

The scheduler entity 404 also determines the timing information related to the radio resources available for transmission of the plurality of data packets of the two packet streams A, and B. For example, as depicted in FIG. 11, the radio resources may comprise of transmit-time slots for the transmission of the plurality of data packets to the two industrial devices 410a, and 410b.

Upon determining the traffic pattern characteristics and the timing information, the scheduler entity 404 determines a delay for one or more data packets. The scheduler entity 404 schedules the plurality of data packets on the transmit-time slots in accordance with the delay determined for the one or more data packets.

For example, the scheduler entity 404 selects the data packets from the packet stream A associated with the delay of zero value. The scheduler entity 404 schedules the selected data packets from the packet stream A on first available transmit time-slots through a modem (an example of the modem 408a), for transmission of the data packets to the one of the industrial devices 410a, and 410b. The scheduler entity 404 buffers the data packets of the packet stream B for later scheduling on the next available transmit-time slots, as the data packets of the packet stream B are associated with the delay of non-zero value. Thus, the data packets arriving from the different packet streams may be delayed in such a way that the data packets between the different packet streams are evenly distributed into the transmit-time slots. In addition, the packet streams A, and B may schedule on the plurality of transmit-time slots with a same periodicity originally generated by the industrial controller 402.

An effect of delaying the one or more data packets results in more spread in the data packets transmitting over the wireless communication network 406. Thereby, reducing a possibility of contention in obtaining the transmit-time slots by the data packets.

In some examples, the network node 406a may use one or more coding schemes for anticipating the delay in arriving of the data packets on the transmit-time slots. Examples of the coding scheme include, but are not limited to, Hybrid Automatic Repeat Request, HARQ re-transmissions and varying coding, a link adaption with multiple modulation and coding schemes, MCSs, and so on.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

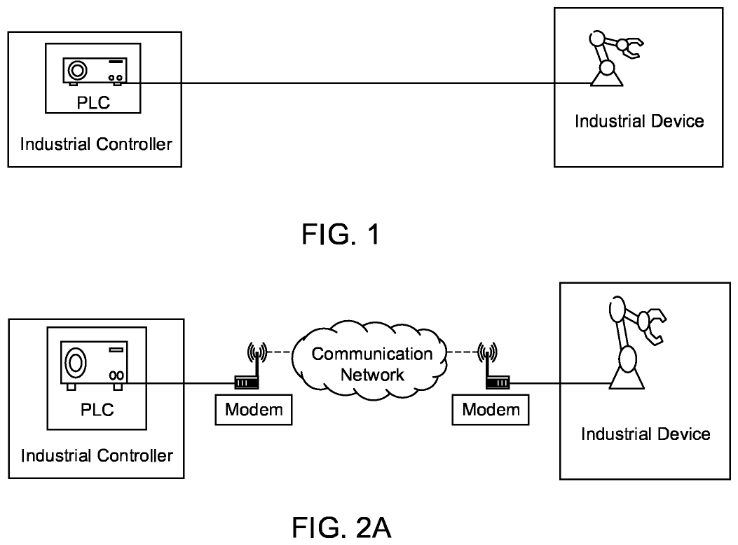

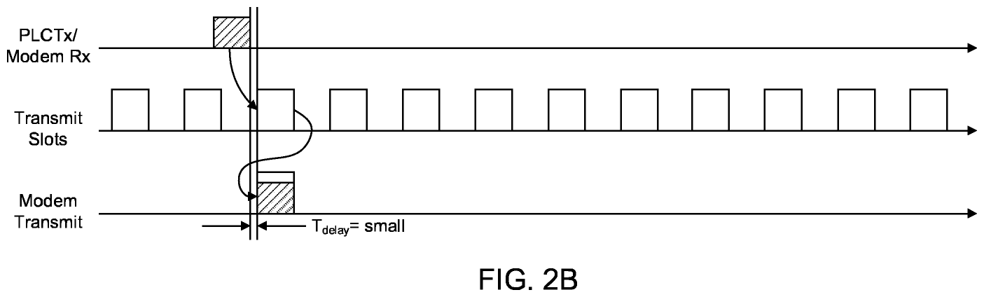

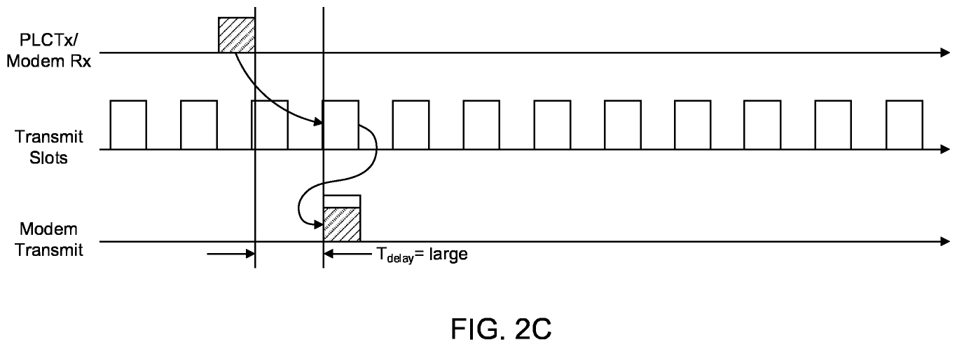

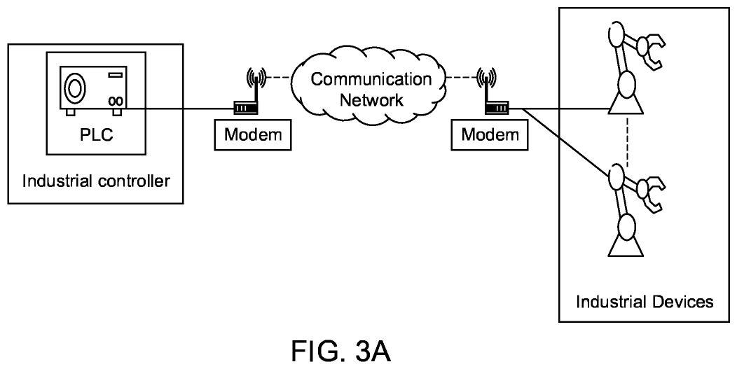

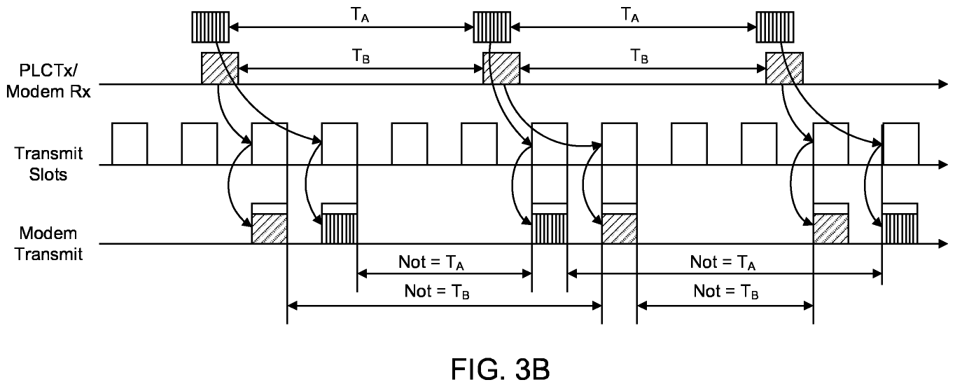

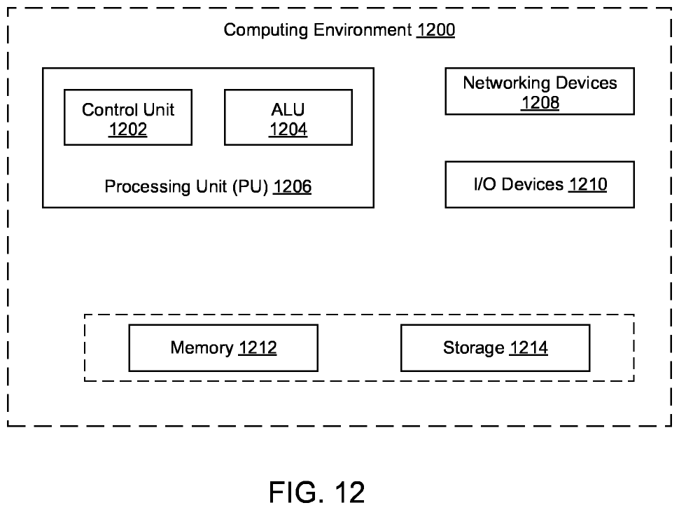

FIG. 12 illustrates an example computing environment 1200 implementing a method and the scheduling entity as described in FIG. 6. As depicted in FIG. 12, the computing environment 1200 comprises at least one data processing module 1206 that is equipped with a control module 1202 and an Arithmetic Logic Unit (ALU) 1204, a plurality of networking devices 1208 and a plurality Input output, I/O devices 1210, a memory 1212, a storage 1214. The data processing module 1206 may be responsible for implementing the method described in FIG. 6. For example, the data processing module 1206 may in some embodiments be equivalent to the processor of the scheduler entity described above in conjunction with the FIGS. 1-11. The data processing module 1206 is capable of executing software instructions stored in memory 1212. The data processing module 1206 receives commands from the control module 1202 in order to perform its processing. Further, any logical and arithmetic operations involved in the execution of the instructions are computed with the help of the ALU 1204.

The computer program is loadable into the data processing module 1206, which may, for example, be comprised in an electronic apparatus (such as a scheduler entity). When loaded into the data processing module 1206, the computer program may be stored in the memory 1212 associated with or comprised in the data processing module 1206. According to some embodiments, the computer program may, when loaded into and run by the data processing module 1206, cause execution of method steps according to, for example, the method illustrated in FIG. 6 or otherwise described herein.

The overall computing environment 1200 may be composed of multiple homogeneous and/or heterogeneous cores, multiple CPUs of different kinds, special media and other accelerators. Further, the plurality of data processing modules 1206 may be located on a single chip or over multiple chips.

The algorithm comprising of instructions and codes required for the implementation are stored in either the memory 1212 or the storage 1214 or both. At the time of execution, the instructions may be fetched from the corresponding memory 1212 and/or storage 1214, and executed by the data processing module 1206.

In case of any hardware implementations various networking devices 1208 or external I/O devices 1210 may be connected to the computing environment to support the implementation through the networking devices 1208 and the I/O devices 1210.

The embodiments disclosed herein can be implemented through at least one software program running on at least one hardware device and performing network management functions to control the elements. The elements shown in FIG. 12 include blocks which can be at least one of a hardware device, or a combination of hardware device and software module.

1. A method for scheduling a plurality of data packets from an industrial controller to one or more industrial devices over a wireless communication network, the method being performed by a scheduler entity, the scheduler entity being connected to the industrial controller, the method comprising:
receiving, from the industrial controller, traffic pattern characteristics associated with the plurality of data packets intended to the one or more industrial devices;
receiving, from a network node in the wireless communication network, timing information related to a plurality of radio resources for transmission of the plurality of data packets; and
scheduling the plurality of data packets on the plurality of radio resources using the traffic pattern characteristics and the timing information related to the plurality of radio resources, wherein a delay is added to least one data packet to provide a spread of the plurality of data packets, wherein the delay of the at least one data packet is added based on the traffic pattern characteristics associated with the plurality of data packets.

2. The method according to claim 1, wherein the plurality of radio resources comprises a plurality of transmit-time slots for the transmission of the plurality of data packets to the one or more industrial devices.

3. The method according to claim 1, wherein the plurality of radio resources are associated with one or more of:
a transmit time interval (TTI);
a subcarrier spacing (SCS) of the wireless communication network;
a transport block size (TBS); and
a modulation and coding scheme (MCS) supported by the wireless communication network.

4. The method according to claim 1, wherein the timing information related to the plurality of radio resources comprises one or more of:
a periodicity of each of the plurality of radio resources; and
a time interval of each of the plurality of radio resources.

5. The method according to claim 1, wherein the traffic pattern characteristics comprise one or more of:
a time interval between the plurality of data packets;
a size of each of the plurality of data packets; and
a priority of each of the plurality of data packets.

6. The method according to claim 1, wherein the step of scheduling the plurality of data packets on the plurality of radio resources comprises:
receiving the plurality of data packets from the industrial controller intended for the one or more industrial devices;
determining the delay for each of the plurality of data packets by analysing the traffic pattern characteristics, and the timing information related to the plurality of resources; and
scheduling the plurality of data packets on the plurality of radio resources in accordance with the delay determined for each of the plurality of data packets.

7. The method according to claim 6, wherein the scheduling the plurality of data packets in accordance with the delay determined for each of the plurality of data packets comprises:
selecting a data packet from the plurality of data packets based on the delay associated with each of the plurality of data packets;
scheduling the selected data packet on a radio resource from the plurality of radio resources for the transmission of the selected data packet to the one or more industrial devices; and
buffering one or more data packets according to an order of the delay associated with the one or more data packets for scheduling on the plurality of radio resources.

8. A scheduler entity configured to operate in an industrial environment for scheduling a plurality of data packets from an industrial controller to one or more industrial devices over a wireless communication network, wherein the scheduler entity being connected to the industrial controller, the scheduler entity being configured for:
receiving, from the industrial controller, traffic pattern characteristics associated with the plurality of data packets intended to the one or more industrial devices;
receiving, from a network node in the wireless communication network, timing information related to a plurality of radio resources for transmission of the plurality of data packets; and
scheduling the plurality of data packets on the plurality of radio resources using the traffic pattern characteristics and the timing information related to the plurality of radio resources, wherein a delay is added to least one data packet to provide a spread of the plurality of data packets, wherein the delay of the at least one data packet is added based on the traffic pattern characteristics associated with the plurality of data packets.

9. The scheduler entity according to claim 8, wherein the plurality of radio resources comprises a plurality of transmit-time slots for the transmission of the plurality of data packets to the one or more industrial devices.

10. The scheduler entity according to claim 8, wherein the plurality of radio resources are associated with one or more of:
a transmit time interval (TTI);
a subcarrier spacing (SCS) of the wireless communication network;
a transport block size (TBS); and
a modulation and coding scheme (MCS) supported by the wireless communication network.

11. The scheduler entity according to claim 8, wherein the timing information related to the plurality of radio resources comprises one or more of:
a periodicity of each of the plurality of radio resources; and
a time interval of each of the plurality of radio resources.

12. The scheduler entity according to claim 8, wherein the traffic pattern characteristics comprise one or more of:
a time interval between the plurality of data packets;
a size of each of the plurality of data packets; and
a priority of each of the plurality of data packets.

13. The scheduler entity according to claim 8, wherein the scheduler entity is configured to cause the scheduling the plurality of data packets on the plurality of resources of the wireless communication network by causing:
receiving the plurality of data packets from the industrial controller intended for the one or more industrial devices;
determining the delay for each of the plurality of data packets by analysing the traffic pattern characteristics, and the timing information related to the plurality of resources; and
scheduling the plurality of data packets on the plurality of radio resources in accordance with the delay determined for each of the plurality of data packets.

14. The scheduler entity according to claim 13, wherein the scheduler entity is configured to cause the scheduling the plurality of data packets in accordance with the delay determined for each of the plurality of data packets by causing:
selecting a data packet from the plurality of data packets based on the delay associated with each of the plurality of data packets;
scheduling the selected data packet on a radio resource from the plurality of radio resources for the transmission of the selected data packet to the one or more industrial devices; and
buffering one or more data packets according to an order of the delay associated with the one or more data packets for scheduling on the plurality of radio resources.

15. (canceled)

16. A scheduler entity configured to operate in a network node in wireless communication network for scheduling a plurality of data packets from an industrial controller to one or more industrial devices over a wireless communication network, the scheduler entity being configured for:
receiving, from the industrial controller, traffic pattern characteristics associated with the plurality of data packets intended to the one or more industrial devices;
receiving, from the network node in the wireless communication network, timing information related to a plurality of radio resources for transmission of the plurality of data packets; and
scheduling the plurality of data packets on the plurality of radio resources using the traffic pattern characteristics and the timing information related to the plurality of radio resources, wherein a delay is added to least one data packet to provide a spread of the plurality of data packets, wherein the delay of the at least one data packet is added based on the traffic pattern characteristics associated with the plurality of data packets.

17. A computer program product comprising a non-transitory computer readable medium, having thereon a computer program comprising program instructions, the computer program is loadable into a data processing unit and configured to cause execution of the method according to claim 1 when the computer program is run by the data processing unit.
